(19) United States
(12) Patent Application Publication
(10) Pub. No.: US 2012/0155699 A1
(43) Pub. Date: Jun. 21, 2012

(54) SPEAKER AND YOKE THEREOF

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/080,608

(22) Filed: Apr. 5, 2011

(30) Foreign Application Priority Data
Dec. 21, 2010 (CN) 201010598764.7

(51) Int. Cl. H04R 1/00

(52) U.S. Cl. 381/433

(57) ABSTRACT

A speaker includes a frame, a yoke located at a bottom side of the frame, a magnet disposed in the yoke, a washer disposed in the yoke and arranged on the magnet, a voice coil and a diaphragm. The yoke includes a bottom wall and an annular sidewall extending upward from a peripheral edge of the bottom wall. The bottom wall and the sidewall cooperatively define a receiving chamber. The sidewall defines a groove in an inner circumferential surface around an axis of the yoke. Outer peripheral surfaces of the magnet and the washer, and the inner circumferential surface of the sidewall of the yoke, cooperatively define an annular air gap. The voice coil encloses the washer. A bottom end of the voice coil is interposed into an upper portion of the air gap. The diaphragm is supported by the frame and is connected to the voice coil.

### BACKGROUND

1. Technical Field

The disclosure generally relates to speakers, and more particularly to a speaker having a yoke providing improved output volume and sensitivity during operation.

2. Description of Related Art

A typical speaker includes a frame, a diaphragm supported by the frame, and a magnetic driving unit. The magnetic driving unit includes a magnet attached to the frame, a magnetic yoke opposing the magnet, and a voice coil disposed between the magnet and the opposing magnetic yoke for driving the diaphragm. In some applications, the size of the speaker is enlarged to increase the output volume and sensitivity of the speaker. However, the volume occupied by the enlarged speaker may be too large for miniaturized applications, and in any event the manufacturing cost of the enlarged speaker is correspondingly increased.

What is needed, therefore, is a speaker to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead placed upon clearly illustrating the principles of the present embodiments. Moreover, in the drawings, like reference numerals designate corresponding parts throughout the views.

FIG. 1 is a cross-sectional view of a speaker in accordance with an exemplary embodiment of the present disclosure.

FIG. 2 is an enlarged, isometric view of a yoke of the speaker of FIG. 1.

### DETAILED DESCRIPTION

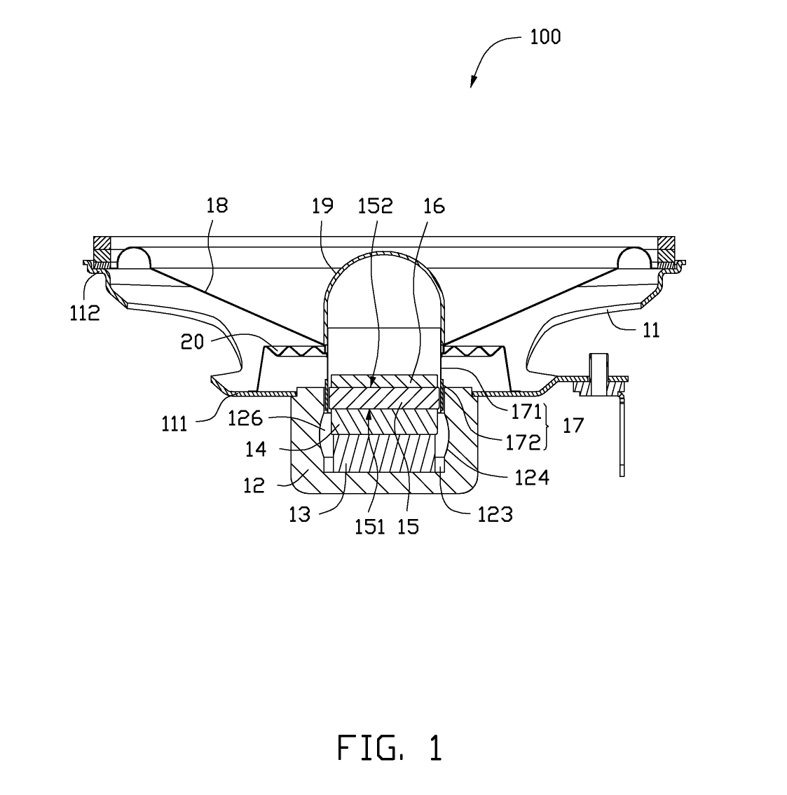

Referring to FIG. 1, a speaker 100 according to an exemplary embodiment of the present disclosure is shown. The speaker 100 includes a frame 11, a yoke 12, a supporting pole 13, a first magnet 14, a washer 15, a second magnet 16, a voice coil 17, a diaphragm 18, a dust cap 19, and a damper 20.

The frame 11 is generally horn-shaped, with a bottom small end 111 and a top big end 112. The yoke 12 is located at a bottom side of the frame 11 and connected to the small end 111 of the frame 11. Alternatively, the yoke 12 can be integrally formed with the frame 11 as a single monolithic piece of the same material.

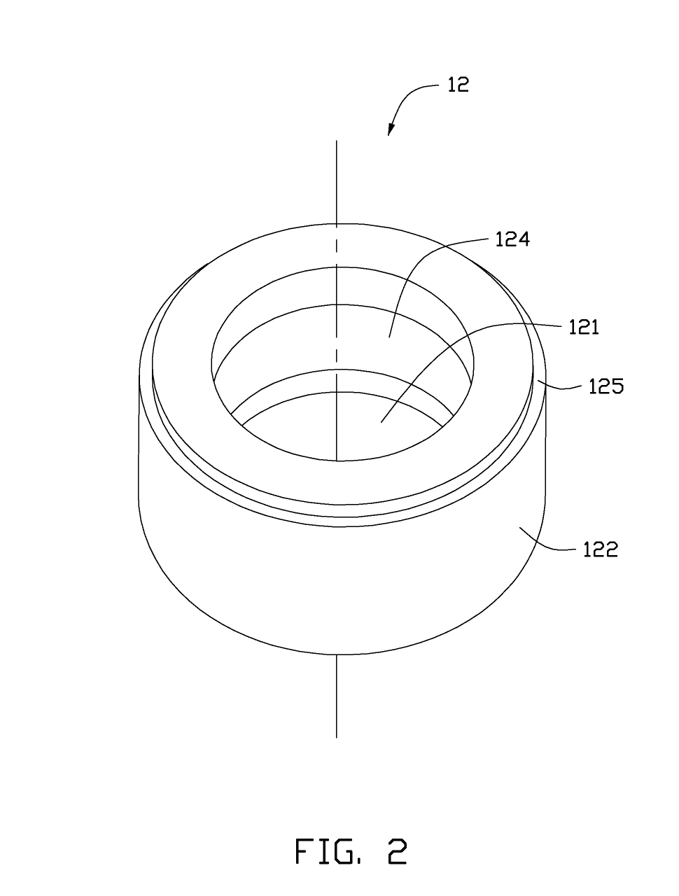

Referring to FIG. 2, the yoke 12 is cup-shaped and has a U-shaped cross-section. The yoke 12 includes a circular bottom wall 121, and an annular (or cylindrical) sidewall 122 extending upward from a peripheral edge of the bottom wall 121. The bottom wall 121 and the sidewall 122 cooperatively define a cylindrical receiving chamber 123 therebetween (see FIG. 1) receiving the supporting pole 13, the first magnet 14 and the washer 15 therein. The sidewall 122 defines an annular groove 124 in an inner circumferential surface thereof, the groove 124 surrounding an axis of the yoke 12. A depth of the groove 124 measured in a radial direction of the yoke 12 is gradually increased from a bottommost extremity of the groove 124 up, and reaches a maximum depth at a vertical midpoint of the groove 124, and then is gradually decreased from the vertical midpoint of the groove 124 up to a topmost extremity of the groove 124. In this embodiment, the groove 124 has an arc-shaped transverse cross-section taken along any radial direction of the yoke 12. A top of the sidewall 122 defines an annular recess 125 in an outer circumferential surface thereof. The bottom small end 111 of the frame 11 engages in the recess 125 to fix the frame 11 on the yoke 12.

Referring back to FIG. 1, the supporting pole 13, the first magnet 14, the washer 15, and the second magnet 16 each are disc-shaped. The supporting pole 13 is received in the receiving chamber 123 of the yoke 12 and is attached to an inner surface of the bottom wall 121 of the yoke 12. The first magnet 14, the washer 15, and the second magnet 16 are successively superposed on the supporting pole 13. The yoke 12 and the supporting pole 13 are made from a magnetic material. The washer 15 has a first surface 151 and a second surface 152 on opposite sides thereof, the first surface 151 facing the first magnet 14. The first surface 151 is higher than the groove 124 of the yoke 12. The second surface 152 is approximately at the same level as a top end surface of the sidewall 122 of the yoke 12. The second magnet 16 is higher than the sidewall 122 of the yoke 12. Outer peripheral surfaces of the supporting pole 13, the first magnet 14, and the washer 15, and the inner circumferential surface of the sidewall 122 of the yoke 12, cooperatively define an annular air gap 126 therebetween.

The voice coil 17 includes a hollow cylindrical bobbin 171, and a coil 172 wound around a bottom end of the bobbin 171. The voice coil 17 encloses the second magnet 16 and the washer 15 therein. The coil 172 of the voice coil 17 is partly interposed into a top of the air gap 126. In the air gap 126, the bobbin 171 and the coil 172 can move forwards and backwards along an axis of the bobbin 171. The coil 172 of the voice coil 17 is aligned with the washer 15 and higher than the groove 124 of the yoke 12.

The dust cap 19 is arranged at a top side of the voice coil 17, and is secured to a top end of the bobbin 171 of the voice coil 17. The diaphragm 18 is formed from a resin or a paper material into a cone shape. The diaphragm 18 is arranged in the frame 11 and around the dust cap 19. A small end of the diaphragm 18 is secured to the dust cap 19, whereby the diaphragm 18 can move together with the voice coil 17. A big end of the diaphragm 18 is secured to the big end 112 of the frame 11. The damper 20 is formed from a resin-impregnated cloth or a thin resin plate into a ring shape. The damper 20 is located between the diaphragm 18 and the small end 111 of the frame 11. The damper 20 encloses the voice coil 17, and connects to the dust cap 19 and the small end 111 of the frame 11.

In the speaker 100, the yoke 12, the supporting pole 13, the first magnet 14, the washer 15, and the second magnet 16 cooperatively constitute a driving unit for driving the coil 172 of the voice coil 17 to move up and down (or forwards and backwards if the speaker 100 is oriented horizontally). Thus, the diaphragm 18 is caused to vibrate together with the voice coil 17 to output sound. Due to the presence of the groove 124 in the inner circumferential surface of the sidewall 122 of the yoke 12, the distribution of the lines of magnetic force emanating form the yoke 12 changes to allow more lines of magnetic force to face towards the coil 172 of the voice coil 17 during operation of the speaker 100. Therefore, the amount of magnetic flux passing through the coil 172 of the voice coil 17 is greatly increased without increasing the size and manufacturing cost of the speaker 100. Accordingly, the output volume and sensitivity of the speaker 100 is increased. In addition, the depth of the groove 124 is gradually increased and then gradually decreased along an upward direction that is parallel to the axis of the yoke 12. Thus, the distribution of the lines of magnetic force emanating from the yoke 12 towards the coil 172 of the voice coil 17 is smoothly varied from the sidewall 122 of the yoke 12 to the coil 172 of the voice coil 17 to avoid cacophony during operation, thereby reducing or even eliminating sound distortion.

In the speaker 100, the supporting pole 13 is supported between the bottom wall 121 of the yoke 12 and the first magnet 14 to provide sufficient space for the voice coil 17 to vibrate during operation. In other embodiments, the supporting pole 13 can be omitted, in which case the first magnet 14 is directly attached to the bottom wall 121 of the yoke 12. In the speaker 100, the second magnet 16 attached on the washer 15 can resist the magnetic force emanating from the first magnet 14 to further increase the amount of magnetic flux passing through the coil 172 of the voice coil 17, thereby further increasing the output volume and sensitivity of the speaker 100.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A yoke for a speaker, the yoke comprising a bottom wall and an annular sidewall extending upwardly from a peripheral edge of the bottom wall, the bottom wall and the sidewall cooperatively defining a receiving chamber therebetween, the sidewall defining a groove in an inner circumferential surface thereof, the groove surrounding an axis of the yoke.

2. The yoke of claim 1, wherein the groove is annular.

3. The yoke of claim 2, wherein a depth of the groove measured in a radial direction of the yoke is gradually increased and then gradually decreased along the axis of the sidewall.

4. The yoke of claim 3, wherein the groove has an arc-shaped cross-section.

5. The yoke of claim 1, wherein a depth of the groove measured in a radial direction of the yoke is gradually increased and then gradually decreased along the axis of the sidewall.

6. A speaker comprising:
a frame;
a yoke located at a bottom side of the frame, the yoke comprising a bottom wall and an annular sidewall extending upwardly from a peripheral edge of the bottom wall, the bottom wall and the sidewall cooperatively defining a receiving chamber therebetween, the sidewall defining a groove in an inner circumferential surface thereof, the groove surrounding an axis of the yoke;
a magnet disposed in the yoke;
a washer disposed in the yoke and arranged on the magnet, outer peripheral surfaces of the magnet and the washer, and the inner circumferential surface of the sidewall of the yoke, cooperatively defining an annular air gap therebetween;
a voice coil enclosing the washer therein, a bottom end of the voice coil being interposed into an upper portion of the air gap; and
a diaphragm supported by the frame and connected to the voice coil.

7. The speaker of claim 6, wherein the groove is annular.

8. The speaker of claim 7, wherein a depth of the groove measured in a radial direction of the yoke is gradually increased and then gradually decreased along the axis of the sidewall.

9. The speaker claim 8, wherein the groove has an arc-shaped cross-section.

10. The speaker of claim 6, wherein the washer has a first surface facing the magnet, the first surface being higher than the groove of the sidewall of the yoke.

11. The speaker of claim 10, wherein the washer further has a second surface opposite to the first surface, the second surface being at the same level as a top end surface of the sidewall of the yoke.

12. The speaker of claim 6, wherein a depth of the groove measured in a radial direction of the yoke is gradually increased and then gradually decreased along the axis of the sidewall.

13. The speaker of claim 6, wherein the voice coil includes a hollow cylindrical bobbin and a coil wound around a bottom end of the bobbin, the coil of the voice coil being interposed into the air gap, the coil of the voice coil being aligned with the washer and higher than the groove of the sidewall of the yoke.

14. The speaker of claim 6, further comprising a supporting pole, the supporting pole being supported between the bottom wall of the yoke and the magnet.

15. The speaker of claim 6, further comprising an additional magnet attached on an outer end surface of the washer.

16. The speaker of claim 6, further comprising a dust cap and damper, the dust cap being secured to a top end of the voice coil, the damper enclosing the voice coil and being connected to the dust cap and the frame.
